(19) United States
(12) Patent Application Publication
(10) Pub. No.: US 2025/0067125 A1
(43) Pub. Date: Feb. 27, 2025

(54) NON-METALLIC UNBONDED FLEXIBLE RISERS FOR DEEP SEA MINING AND MANUFACTURING METHOD THEREOF

(71) Applicants: CNINA UNIVERSITY OF PETROLEUM-BEIJING, Beijing (CN); WEIHAI HONGTONG PIPING MATERIALS CO., LTD, Weihai (CN)

(72) Inventors: Yingying WANG, Beijing (CN); Haibo Sun, Beijing (CN); Chuanbo Cong, Beijing (CN); Liwei Li, Beinjing (CN); Lusheng Jia, Beijing (CN); Zhaojun LV, Weihai (CN); Ke Zhang, Beijing (CN); Yufang Li, Beijing (CN); Wei Kong, Beijing (CN); Zeqing Lin, Beijing (CN); Hao Yu, Beijing (CN); Xingwei Li, Weihai (CN); Yangdong Hu, Beijing (CN); Guoan Shen, Beijing (CN)

(21) Appl. No.: 18/678,467

(22) Filed: May 30, 2024

(30) Foreign Application Priority Data
Aug. 24, 2023 (CN) 202311074049.7

(51) Int. Cl. E21B 17/01; B29C 48/00; B29C 63/10; B29K 23/00; B29K 105/00; B29K 105/10; B29L 23/00; F16L 11/08; F16L 11/12

(52) U.S. Cl. CPC E21B 17/01; B29C 48/0021; B29C 63/10; F16L 11/083; F16L 11/12; B29K 2023/0683; B29K 2105/0097; B29K 2105/103; B29L 2023/005

(57) ABSTRACT

The present invention relates to a nonmetallic unbonded flexible riser for deep-sea mining and a manufacturing method thereof, wherein the riser includes a lining layer, an internal pressure resistant reinforcing layer, a first anti-wear layer, a first compensation reinforcing layer, a second anti-wear layer, a second compensation reinforcing layer, a third anti-wear layer, a framework layer, a isolation layer, a first tensile reinforcing layer, a fourth anti-wear layer, a second tensile reinforcing layer and an outer coating layer which are sequentially arranged from inside to outside, wherein unbonded connection between adjacent layers is adopted. The present invention may ensure the continuous transportation of the mineral and the seawater inside the flexible mixed transportation pipe, adapt to the severe marine environment and loading condition, and ensure the safety of mining work.

### TECHNICAL FIELD

The present invention relates to the technical field of deep sea mining, and specifically relates to a nonmetallic unbonded flexible risers for deep-sea mining and a manufacturing method thereof.

### BACKGROUND

Polymetallic nodules are a type of deep sea mineral resource that are widely distributed at the international seabed at the depth of 4000-6000 meters,. with huge reserves estimated to reach up to 200 billion tons. This lead to a great commercial mining value. As “A big artery” of the deep-sea mining system, a flexible riser is a transportation carrier of minerals and is also the most critical transportation equipment in a hydraulic lifting mining system.

However, in one existing art, Chen Chaohe et al. disclosed a composite flexible riser, which arranged from inside to outside sequentially comprises a framework layer, a inner lining layer, a pressure resistant armoring layer, a middle protective sleeve layer, a cable hole layer, a first tensile armoring layer, a second tensile armoring layer and an outer protective sleeve layer. A first anti-wear layer is provided between the cable hole layer and the first tensile armoring layer; a second anti-wear layer is provided between the first tensile armoring layer and the second tensile armoring layer. The material of the pressure resistant armoring layer may be carbon steel or high-strength steel, and the material of the framework layer may be stainless steel, nickel alloy steel or molybdenum alloy steel. Chen's disclosure relates to the field of metal unbonded flexible riser and has the following disadvantages: high weight density, poor wear resistance and poor corrosion resistance.

In another existing art, Wang Sen et al. disclosed a large-diameter thermoplastic composite long distance transportation pipe, belonging to a nonmetallic bonded flexible pipe, with a structure of a lining layer, a fiber reinforcing layer and an outer protective layer which are sequentially arranged from inside to outside. The lining layer and the outer protective layer are formed by adopting thermoplastic polymer material extrusion molding process, and the fiber reinforcing layer is formed by 3D composite printing with a high-strength fiber and a thermoplastic polymer. This nonmetallic bonded flexible pipe has the following disadvantages: the layers are bonded as an integrated structure, therefore bending radius does not meet usage requirements for preparation of large diameter pipes; furthermore, fatigue resistance is poor and it is prone to failure due to the structure of bonded type pipe; in addition, when working in ultra-deep water environment, the comprehensive performance of the structure cannot meet an extreme internal and external pressure and a tip pulling force, and it is very easy to cause strength damage to the pipe body.

In another existing art, Cong Chuanbo et al. disclosed a nonmetallic flexible pipe, comprising a lining layer, a pressure bearing layer, an isolation layer, a tensile layer, a functional layer and a protective layer which are sequentially arranged from inside to outside. The pressure bearing layer adopts an interlocking mode, and adjacent two layers are non-rigidly bonded. The flexible pipe has the following disadvantages: the flexible pipe of this invention is applicable for hydrate mining and has nonmetallic and unbonded structural form, such design is only capable of functioning at the depth of 1,500 meters under water, considered with the structural form of the pressure bearing layer and the number of tensile reinforcing layer, the pipe body has poor flexibility, and it cannot be applied to an ultra-deep-sea mining at the depth of 6,000 m; at the same time, in order to ensure that the composite material can be softened twice and then wound, the composite material matrices used in this invention are all thermoplastic materials, which can produce permanent deformation under large stress condition, so that the structure of the pipe body will change and cause failure.

### SUMMARY

In view of the above problems, the purpose of the present invention is to provide a nonmetallic unbonded flexible riser for deep-sea mining and a manufacturing method thereof, which can ensure the continuous transportation of mineral and seawater inside the pipe, and the pipe can be adapted to severe marine environment and loading condition, and ensure safety of deep sea mining operations.

In order to achieve the above objects, the present invention adopts the following technical solutions:

The nonmetallic unbonded flexible riser for deep-sea mining according to the present invention, comprising a lining layer, an internal pressure resistant reinforcing layer, a first anti-wear layer, a first compensation reinforcing layer, a second anti-wear layer, a second compensation reinforcing layer, a third anti-wear layer, a framework layer, a isolation layer, a first tensile reinforcing layer, a fourth anti-wear layer, a second tensile reinforcing layer and an outer coating layer which are sequentially arranged from inside to outside, wherein unbonded connection between adjacent layers is adopted.

For the nonmetallic unbonded flexible riser for deep-sea mining, preferably, material of the lining layer is ultra-high molecular weight polyethylene; an inner diameter of the lining layer is not less than 200 mm and thickness of the lining layer is 8-15 mm.

For the nonmetallic unbonded flexible riser for deep-sea mining, preferably, the internal pressure resistant reinforcing layer is formed by winding or weaving a fiber, which is then impregnated with thermosetting resin, and is cured to form a cylindrical structure; a winding angle of the fiber is 75°-85°. The fiber is carbon fiber, glass fiber or aramid fiber. Thickness of the internal pressure resistant reinforcing layer is 1-5 mm.

For the nonmetallic unbonded flexible riser for deep-sea mining, preferably, each of the first compensation reinforcing layer, the second compensation reinforcing layer, the framework layer, the first tensile reinforcing layer and the second tensile reinforcing layer is continuous long fiber reinforcing resin matrix composite material employing a matrix cured into a helical ribbon, which has a strip with a rectangular cross-section.

For the nonmetallic unbonded flexible riser for deep-sea mining, preferably, soft plastic or rubber is provided between adjacent helical ribbons.

For the nonmetallic unbonded flexible riser for deep-sea mining, preferably, strip reinforcing materials of the first compensation reinforcing layer and the second compensation reinforcing layer are carbon fiber, glass fiber or aramid fiber; a winding angle of the strip is between 30°-75°, width of the strip is 10-50 mm, and thickness of the strip is 1-10 mm; the first compensation reinforcing layer and the second compensation reinforcing layer are wound at same winding angle and in opposite directions. Strip reinforcing material of the framework layer is carbon fiber, glass fiber or aramid fiber, etc., a strip winding angle is between 75°-85°, a number of the strip is 1-3, and thickness of the strip is 5-15 mm. Strip reinforcing materials of the first tensile reinforcing layer and the second tensile reinforcing layer are carbon fiber, glass fiber or aramid fiber. A winding angle of the strip is between 25°-35°, width of the strip is between 10-50 mm, and thickness of the strip is 1-10 mm. The first tensile reinforcing layer and the second tensile reinforcing layer are wound at same angle and in opposite directions.

For the nonmetallic unbonded flexible riser for deep-sea mining, preferably, the first anti-wear layer, the second anti-wear layer, the third anti-wear layer and the fourth anti-wear layer are all made of polyvinyl chloride material, and strips thereof are wound at a winding angle of 70°-80°.

For the nonmetallic unbonded flexible riser for deep-sea mining, preferably, materials of the isolation layer and the outer coating layer are thermoplastic polyurethane; wherein, the isolation layer is extruded from a thermoplastic polyethylene material, and thickness of the isolation layer is 1-10 mm; wherein, the outer coating layer is also extruded from thermoplastic polyurethane material, and thickness of the outer coating layer is 1-10 mm.

The manufacturing method of the nonmetallic unbonded flexible riser for deep-sea mining according to the present invention includes the following steps:
stacking and providing a lining layer, an internal pressure resistant reinforcing layer, a first anti-wear layer, a first compensation reinforcing layer, a second anti-wear layer, a second compensation reinforcing layer, a third anti-wear layer, a framework layer, an isolation layer, a first tensile reinforcing layer, a fourth anti-wear layer, a second tensile reinforcing layer and an outer coating layer which are sequentially arranged from inside to outside.

Wherein, the lining layer, isolation layer and outer coating layer are all formed by adopting a thermoplastic extrusion process, whereby the polymer is melted and extruded, and finally cooled and molded.

Wherein, the internal pressure resistant reinforcing layer is molded by winding internal fibers, which are impregnated in resin, then are directly wound on the lining layer in multiple layers, and are finally cured, with a winding angle between 75°-85°, to ultimately form an integral pipe tube structure.

Wherein, the first compensation reinforcing layer, the second compensation reinforcing layer, the framework layer, the first tensile reinforcing layer and the second tensile reinforcing layer are all formed by winding with continuous long fiber reinforcing strips. Specifically, fibers are gathered into a fiber bundle through a gathering device, are processed by impregnating with a resin glue through a glue tank, and then excess glue is squeezed out through an extruding device to ensure that the fiber bundle is fully contacted with glue; a fully glue-impregnated fiber bundle is wound and molded into a strip through a helical mold, which can control width, thickness, and winding angle of the strip.

For the manufacturing method, preferably, the first compensation reinforcing layer and the second compensation reinforcing layer are wound and molded at a winding angle between 30° and 75°, the framework layer is wound and molded at a winding angle between 75°-85°, and the first tensile reinforcing layer and the second tensile reinforcing layer are wound at a winding angle between 25°-35°; fiber volume content in the continuous long fiber reinforcing strip is between 80%-75% and the rest is unsaturated polyester matrix.

Since the present invention adopts the above technical solutions, it has the following advantages:

The nonmetallic unbonded flexible riser of the present invention has the following advantages: high wear resistance, light weight, high corrosion resistance, good bending performance, strong fatigue resistance, etc., and may be used in a 6000-meter depth deep-sea mining hydraulic lifting system. The present invention fill a gap of nonmetallic unbonded flexible pipe for deep-sea mining application, which improves safety and reliability of deep-sea mining hydraulic lifting systems and promotes a rapid development of deep-sea mining manganese nodule exploitation engineering technology.

### BRIEF DESCRIPTION OF THE DRAWINGS

Various other advantages and benefits will become apparent to those of ordinary skill in the art upon reading the following detailed description of the preferred embodiments. The drawings are for the purpose of illustrating preferred embodiments only and are not to be construed as limiting the present invention. Throughout the drawings, the same reference number refer to the same part. In the drawings:

FIG. 1 is a schematic structural diagram of the flexible mixed transportation pipe of the present invention;

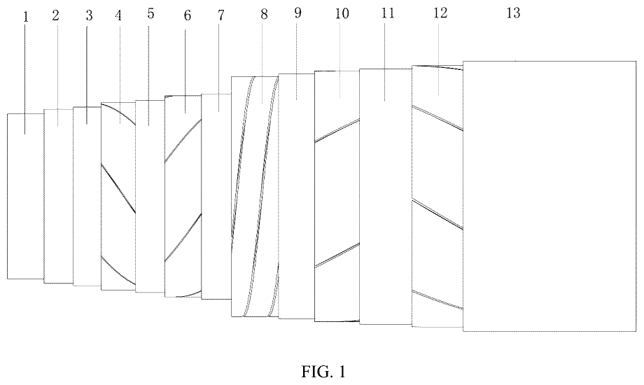

FIG. 2 is a schematic radial cross-sectional structural diagram of FIG. 1.

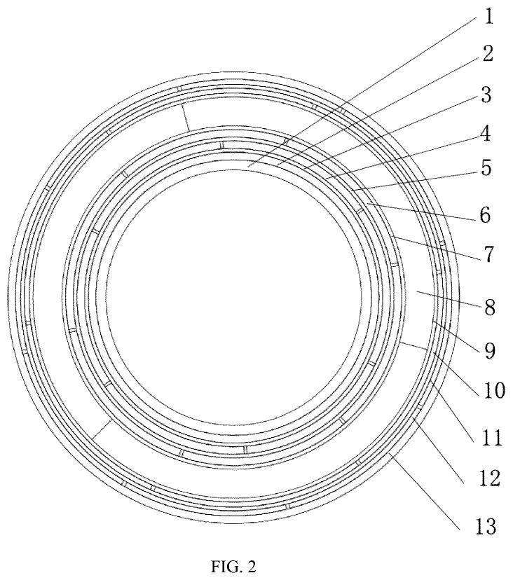

Reference numbers in the drawings are as follows:
1—Lining layer; 2—Internal pressure resistant reinforcing layer; 3—First anti—wear layer; 4—First compensation reinforcing layer; 5—Second anti—wear layer; 6—Second compensation reinforcing layer; 7—Third anti—wear layer; 8—Framework layer; 9—Isolation layer; 10—First tensile reinforcing layer; 11—Fourth anti-wear layer; 12—Second tensile reinforcing layer; 13—Outer coating layer.

### DETAILED DESCRIPTION

Exemplary embodiments of the present invention will be described in more detail below with reference to the accompanying drawings. Although exemplary embodiments of the present invention are shown in the drawings, it should be understood that the present invention may be embodied in various forms and should not be limited to the embodiments set forth herein. Rather, these embodiments are provided to provide a thorough understanding of the present invention, and to fully convey the scope of the present invention to those skilled in the art.

The present invention provides a nonmetallic unbonded flexible riser for deep-sea mining. The lining layer has super wear resistance performance; the compensation reinforcing layer has comprehensive performance of both internal pressure resistant and tensile resistant; the isolation layer can not only serve as an interlayer wear resistance layer, but also act as an outer protective layer to prevent further intrusion of seawater if the outer protective layer fails; the winding structure of the compensation reinforcing layer, the framework layer and the tensile reinforcing layer can fully ensure the bending performance of the flexible pipe; the compensation reinforcing layer, the framework layer and the tensile reinforcing layer are all fiber-impregnated with liquid resin materials, and then cured to finally form a helical thermosetting resin composite material. Therefore, the present invention can fully utilize the above advantages, adapt to severe marine environment and load condition, and ensure the safety of mining work.

The nonmetallic unbonded flexible riser for deep-sea mining according to the present invention, comprising a lining layer 1, an internal pressure resistant reinforcing layer 2, a first anti-wear layer 3, a first compensation reinforcing layer 4, a second anti-wear layer 5, a second compensation reinforcing layer 6, a third anti-wear layer 7, a framework layer 8, a isolation layer 9, a first tensile reinforcing layer 10, a fourth anti-wear layer 11, a second tensile reinforcing Layer 12 and an outer coating layer 13 which are sequentially arranged from inside to outside, wherein unbonded connection between adjacent layers is adopted.

In the above embodiment, preferably, material of the lining layer 1 is ultra-high molecular weight polyethylene; an inner diameter of the lining layer 1 is not less than 200 mm, and thickness is 8-15 mm.

In the above embodiment, preferably, the internal pressure resistant reinforcing layer 2 is formed by winding or weaving fiber, impregnating with thermosetting resin, and then curing to a cylindrical structure. A winding angle of the fiber is 75°-85°. The fiber is carbon fiber, glass fiber or aramid fiber. Thickness of the internal pressure resistant reinforcing layer 2 is 1-5 mm.

In the above embodiment, preferably, each of the first compensation reinforcing layer 4, the second compensation reinforcing layer 6, the framework layer 8, the first tensile reinforcing layer 10 and the second tensile reinforcing layers 12 is continuous long fiber reinforcing resin matrix composite material employing a matrix cured into a helical ribbon, which has a strip with a rectangular cross-section.

In the above embodiment, preferably, soft plastic or rubber is provided between adjacent helical ribbons. As a result, mutual friction between the strips may be prevented.

In the above embodiment, preferably, strip reinforcing materials of the first compensation reinforcing layer 4 and the second compensation reinforcing layer 6 are carbon fiber, glass fiber or aramid fiber; a winding angle of the strip is between 30°-75°, width of the strip is between 10-50 mm, and thickness of the strip is between 1-10 mm; The first compensation reinforcing layer 4 and the second compensation reinforcing layer 6 are wound at same winding angle and in opposite directions, thereby, torsion effect of the strips under tension may be mutually counteracted.

Strip reinforcing material of the framework layer 8 is carbon fiber, glass fiber or aramid fiber, etc., a winding angle of the strip is between 75°-85°, number of the strip is 1-3, and thickness is 5-15 mm; thus, it may bear main pressure outside the pipe and provide bending performance to ensure that the pipe body has better flexibility.

The strip reinforcing material of the first tensile reinforcing layer 10 and the second tensile reinforcing layer 12 is carbon fiber, glass fiber or aramid fiber. A winding angle of the strip is between 25°-35°, width of the strip is between 10-50 mm, and thickness of the strip is 1-10 mm; the first tensile reinforcing layer 10 and the second tensile reinforcing layer 12 are wound at same angle and in opposite directions, thereby, torsion effect of the strips under tension may be mutually counteracted.

In the above embodiment, preferably, the first anti-wear layer 3, the second anti-wear layer 5, the third anti-wear layer 7 and the fourth anti-wear layer 11 are all made of polyvinyl chloride material, and the strips thereof are wound at a winding angle between 70° and 80°, thereby, wear between various reinforcing layers may be avoided, and pressure bearing strength of pipe body may be ensured.

In the above embodiment, preferably, materials of the isolation layer 9 and the outer coating layer 13 are thermoplastic polyurethane; wherein, the isolation layer 9 is extruded from a thermoplastic polyethylene material, and thickness of the isolation layer is 1-10 mm. The isolation layer has functions of resisting wear and isolating seawater both; wherein, the outer coating layer 13 is also extruded from thermoplastic polyurethane material and thickness of the outer coating layer is 1-10 mm. The main function of the outer coating layer is to isolate seawater.

Structure and material of the pipe body adopted by the nonmetallic unbonded flexible riser of the present invention ensure its super wear resistance, corrosion resistance, fatigue resistance and strong bending performance, adapt to the internal pressure load of 60 MPa and the top tension load of 600 t, and can fully satisfy requirement of mining minerals in ultra-deep water of 6000 m.

The present invention also provides a manufacturing method of a nonmetallic unbonded flexible riser for deep-sea mining, comprising the following steps:

Stacking and providing the lining layer 1, the internal pressure resistant reinforcing layer 2, the first anti-wear layer 3, the first compensation reinforcing layer 4, the second anti-wear layer 5, the second compensation reinforcing layer 6, the third anti-wear layer 7, the framework layer 8, the isolation layer 9, the first tensile reinforcing layer 10, the fourth anti-wear layer 11, the second tensile reinforcing layer 12 and the outer coating layer 13 which are sequentially arranged from inside to outside.

Wherein, the lining layer 1, the isolation layer 9 and the outer coating layer 13 are all formed by adopting a thermoplastic extrusion process, whereby the polymer is melted and extruded, and finally cooled and molded.

Wherein, the internal pressure resistant reinforcing layer 2 is molded by winding internal fibers, which are impregnated in resin, then are directly wound on the lining layer in multiple layers, and are finally cured, with a winding angle between 75°-85°, to ultimately form an integral pipe tube structure.

Wherein, the first compensation reinforcing layer 4, the second compensation reinforcing layer 6, the framework layer 8, the first tensile reinforcing layer 10 and the second tensile reinforcing layer 12 are all formed by winding with continuous long fiber reinforcing strips, specifically, fibers are gathered into a fiber bundle through a gathering device, are processed by impregnating with a resin glue through a glue tank, and then the excess glue is squeezed out through an extruding device to ensure that the fiber bundles are fully contacted with glue. A fully glue-impregnated fiber bundle is wound and molded into a strip through a helical mold, which can control width, thickness, and winding angle of the strip.

In the above embodiment, preferably, the first compensation reinforcing layer 4 and the second compensation reinforcing layer 6 are wound and molded at a winding angle between 30° and 75°, the framework layer 8 is wound and molded at a winding angle between 75°-85°, and the first tensile reinforcing layer 10 and the second tensile reinforcing layer 12 are wound at a winding angle between 25°-35°; fiber volume content in the continuous long fiber reinforcing strip is between 80%-75% and the rest is unsaturated polyester matrix.

Finally, it should be noted that the above embodiments are only used to illustrate the technical solutions of the present invention, but not to limit them; although the present invention has been described in detail with reference to the foregoing embodiments, a person of ordinary skill in the art should understand that it is still possible to make modifications to the technical solutions described in the foregoing embodiments, or equivalent substitutions are made to some of the technical features; however, these modifications or substitutions do not cause the essence of the corresponding technical solutions to deviate from the spirit and scope of the technical solutions of the embodiments of the present invention.

1. A nonmetallic unbonded flexible riser for deep-sea mining, wherein comprising a lining layer, an internal pressure resistant reinforcing layer, a first anti-wear layer, a first compensation reinforcing layer, a second anti-wear layer, a second compensation reinforcing layer, a third anti-wear layer, a framework layer, a isolation layer, a first tensile reinforcing layer, a fourth anti-wear layer, a second tensile reinforcing layer and an outer coating layer which are sequentially arranged from inside to outside, wherein unbonded connection between adjacent layers is adopted.

2. The nonmetallic unbonded flexible riser for deep-sea mining according to claim 1, wherein material of the lining layer is ultra-high molecular weight polyethylene;
an inner diameter of the lining layer is not less than 200 mm and thickness of the lining layer is 8-15 mm.

3. The nonmetallic unbonded flexible riser for deep-sea mining according to claim 1, wherein the internal pressure resistant reinforcing layer is formed by winding or weaving a fiber, which is then impregnated with thermosetting resin, and is cured to form a cylindrical structure;
a winding angle of the fiber is 75°-85°, the fiber is carbon fiber, glass fiber or aramid fiber;
thickness of the internal pressure resistant reinforcing layer is 1-5 mm.

4. The nonmetallic unbonded flexible riser for deep-sea mining according to claim 1, wherein each of the first compensation reinforcing layer, the second compensation reinforcing layer, the framework layer, the first tensile reinforcing layer and the second tensile reinforcing layer is continuous long fiber reinforcing resin matrix composite material employing a matrix cured into a helical ribbon, which has a strip with a rectangular cross-section.

5. The nonmetallic unbonded flexible riser for deep-sea mining according to claim 4, wherein soft plastic or rubber is provided between adjacent helical ribbons.

6. The nonmetallic unbonded flexible riser for deep-sea mining according to claim 4, wherein:
strip reinforcing materials of the first compensation reinforcing layer and the second compensation reinforcing layer are carbon fiber, glass fiber or aramid fiber; a winding angle of the strip is between 30°-75°, width of the strip is 10-50 mm, and thickness of the strip is 1-10 mm; the first compensation reinforcing layer and the second compensation reinforcing layer are wound at same winding angle and in opposite directions;
strip reinforcing material of the framework layer is carbon fiber, glass fiber or aramid fiber, etc., a strip winding angle is between 75°-85°, number of the strip is 1-3, and thickness of the strip is 5-15 mm;
strip reinforcing materials of the first tensile reinforcing layer and the second tensile reinforcing layer are carbon fiber, glass fiber or aramid fiber, a winding angle of the strip is between 25°-35°, width of the strip is between 10-50 mm, and thickness of the strip is 1-10 mm; the first tensile reinforcing layer and the second tensile reinforcing layer are wound at same angle and in opposite directions.

7. The nonmetallic unbonded flexible riser for deep-sea mining according to claim 1, wherein the first anti-wear layer, the second anti-wear layer, the third anti-wear layer and the fourth anti-wear layer are all made of polyvinyl chloride material, and strips thereof are wound at a winding angle of 70°-80°.

8. The nonmetallic unbonded flexible riser for deep-sea mining according to claim 1, wherein materials of the isolation layer and the outer coating layer are thermoplastic polyurethane;
wherein, the isolation layer is extruded from a thermoplastic polyethylene material, and thickness of the isolation layer is 1-10 mm;
wherein, the outer coating layer is also extruded from thermoplastic polyurethane material, and thickness of the outer coating layer is 1-10 mm.

9. A method for manufacturing a nonmetallic unbonded flexible riser for deep-sea mining according to claim 1, wherein it includes the following steps:
stacking and providing a lining layer, an internal pressure resistant reinforcing layer, a first anti-wear layer, a first compensation reinforcing layer, a second anti-wear layer, a second compensation reinforcing layer, a third anti-wear layer, a framework layer, an isolation layer, a first tensile reinforcing layer, a fourth anti-wear layer, a second tensile reinforcing layer and an outer coating layer which are sequentially arranged from inside to outside;
wherein, the lining layer, isolation layer and outer coating layer are all formed by adopting a thermoplastic extrusion process, whereby the polymer is melted and extruded, and finally cooled and molded;
wherein, the internal pressure resistant reinforcing layer is molded by winding internal fibers, which are impregnated in resin, then are directly wound on the lining layer in multiple layers, and are finally cured, with a winding angle between 75°-85°, to ultimately form an integral pipe tube structure;
wherein, the first compensation reinforcing layer, the second compensation reinforcing layer, the framework layer, the first tensile reinforcing layer and the second tensile reinforcing layer are all formed by winding with continuous long fiber reinforcing strips, specifically, fibers are gathered into a fiber bundle through a gathering device, are processed by impregnating with a resin glue through a glue tank, and then excess glue is squeezed out through an extruding device to ensure that the fiber bundle is fully contacted with glue; a fully glue-impregnated fiber bundle is wound and molded into a strip through a helical mold, which can control width, thickness, and winding angle of the strip.

10. The manufacturing method according to claim 9, wherein:
the first compensation reinforcing layer and the second compensation reinforcing layer are wound and molded at a winding angle between 30° and 75°, the framework layer is wound and molded at a winding angle between 75°-85°, and the first tensile reinforcing layer and the second tensile reinforcing layer are wound at a winding angle between 25°-35°;
fiber volume content in the continuous long fiber reinforcing strip is between 80%-75% and the rest is unsaturated polyester matrix.
